(19) United States
(12) Patent Application Publication
(10) Pub. No.: US 2019/0120934 A1
(43) Pub. Date: Apr. 25, 2019

(54) THREE-DIMENSIONAL ALIGNMENT OF RADAR AND CAMERA SENSORS

(71) Applicant: GM Global Technology Operations LLC, Detroit, MI (US)

(72) Inventors: Michael Slutsky, Kfar Saba (IL); Daniel I. Dobkin, Tel Aviv (IL); Shahar Villeval, Tel Aviv (IL); Igal Bilik, Rehovot (IL)

(21) Appl. No.: 15/788,048

(22) Filed: Oct. 19, 2017

(51) Int. Cl. G01S 7/40; G01S 13/86; G06T 7/73; G06T 7/33

(52) U.S. Cl. CPC G01S 7/4026; G01S 13/867; G01S 13/931; G06T 7/33; G06T 7/73

(57) ABSTRACT

A system and method to perform a three-dimensional alignment of a radar and a camera with an area of overlapping fields of view position a corner reflector within the area. The method includes obtaining sensor data for the corner reflector with the radar and the camera, and iteratively repositioning the corner reflector within the area and repeating the obtaining the sensor data. A rotation matrix and a translation vector are determined that align the radar and the camera such that a three-dimensional detection by the radar projects to a location on a two-dimensional image obtained by the camera according to the rotation matrix and the translation vector.

### INTRODUCTION

The subject disclosure relates to three-dimensional (3D) alignment of radar and camera sensors.

Vehicles (e.g., automobiles, farm equipment, automated factory equipment, construction equipment) increasingly include sensor systems that facilitate augmented or automated actions. For example, light detection and ranging (lidar) and radio detection and ranging (radar) sensors respectively emit light pulses or radio frequency energy and determine range and angle to a target based on reflected light or energy that is received and processed. A camera (e.g., still, video) facilitates target classification (e.g., pedestrian, truck, tree) using a neural network processor, for example. In autonomous driving, sensors must cover all 360 degrees around the vehicle. More than one type of sensor covering the same area provides functional safety and complementary information through sensor fusion. In this respect, the sensors must be geometrically aligned to provide sensing within a shared field of view (FOV). Yet, different types of sensors (e.g., radar, camera) obtain different types of information in different coordinate spaces. Accordingly, it is desirable to provide 3D alignment of radar and camera sensors.

### SUMMARY

In one exemplary embodiment, a method of performing a three-dimensional alignment of a radar and a camera with an area of overlapping fields of view includes positioning a corner reflector within the area, and obtaining sensor data for the corner reflector with the radar and the camera. The method also includes iteratively repositioning the corner reflector within the area and repeating the obtaining the sensor data, and determining a rotation matrix and a translation vector to align the radar and the camera such that a three-dimensional detection by the radar projects to a location on a two-dimensional image obtained by the camera according to the rotation matrix and the translation vector.

In addition to one or more of the features described herein, the obtaining sensor data with the camera includes determining a position of a light emitting diode disposed at an apex position of the corner reflector in an image of the corner reflector.

In addition to one or more of the features described herein, the obtaining the sensor data with the radar includes detecting the apex position of the corner reflector as a point target.

In addition to one or more of the features described herein, the method includes mapping a three-dimensional position obtained by operating on a radar detection with the rotation matrix and the translation vector to the location on the two-dimensional image.

In addition to one or more of the features described herein, the method includes defining a cost function as a sum of squared Mahalanobis distances between a location of a center of the corner reflector as determined by the camera and the location of the center of the corner reflector as determined by the radar and projected on the two-dimensional image obtained by the camera for each position of the corner reflector in the area.

In addition to one or more of the features described herein, the determining the rotation matrix and the translation vector includes determining the rotation matrix and the translation vector that minimize the cost function.

In addition to one or more of the features described herein, the determining the rotation matrix includes determining three angle values.

In addition to one or more of the features described herein, the determining the translation vector includes determining three position components.

In addition to one or more of the features described herein, the obtaining the sensor data with the camera includes using a pinhole camera.

In addition to one or more of the features described herein, the obtaining the sensor data with the camera includes using a fisheye camera.

In another exemplary embodiment, a system to align a radar and a camera with an area of overlapping fields of view includes a camera to obtain camera sensor data for a corner reflector positioned at different locations within the area, and a radar to obtain radar sensor data for the corner reflector at the different locations within the area. The system also includes a controller to determine a rotation matrix and a translation vector to align the radar and the camera such that a three-dimensional detection by the radar projects to a location on a two-dimensional image obtained by the camera according to the rotation matrix and the translation vector.

In addition to one or more of the features described herein, the camera determines a position of a light emitting diode disposed at an apex position of the corner reflector in an image of the corner reflector.

In addition to one or more of the features described herein, the radar detects the apex position of the corner reflector as a point target.

In addition to one or more of the features described herein, the controller maps a three-dimensional position obtained by operating on a radar detection with the rotation matrix and the translation vector to the location on the two-dimensional image.

In addition to one or more of the features described herein, the controller defines a cost function as a sum of squared Mahalanobis distances between a location of a center of the corner reflector as determined by the camera and the location of the center of the corner reflector as determined by the radar and projected on the two-dimensional image obtained by the camera for each position of the corner reflector in the area.

In addition to one or more of the features described herein, the controller determines the rotation matrix and the translation vector to minimize the cost function.

In addition to one or more of the features described herein, the controller determines the rotation matrix as three angle values.

In addition to one or more of the features described herein, the controller determines the translation vector as three position components.

In addition to one or more of the features described herein, the camera is a pinhole camera, and the pinhole camera and the radar are in a vehicle.

In addition to one or more of the features described herein, the camera is a fisheye camera, and the fisheye camera and the radar are in a vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that performs three-dimensional alignment of radar and camera sensors according to one or more embodiments;

FIG. 2 depicts an exemplary arrangement to perform three-dimensional alignment of the radar and camera according to one or more embodiments; and

FIG. 3 is a process flow of a method of performing three-dimensional alignment of radar and camera sensors according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, vehicles increasingly include sensor systems such as radar and camera sensors. In an autonomous vehicle or a vehicle with autonomous features (e.g., autonomous parking), coverage of 360 degrees around the vehicle with more than one sensor facilitates obtaining complementary information through sensor fusion. However, sensor fusion (i.e., combining of data obtained by each sensor) requires geometric alignment of the sensors that share a FOV. If sensors are not aligned, detections by one sensor that are transformed to the frame of reference of the other sensor will project at the wrong coordinates. For example, radar detections that are transformed to the camera frame of reference will project at wrong image coordinates. Thus, the distance, in pixels, between the projected and the actual image locations is a measure of the misalignment of the sensors.

Embodiments of the systems and methods detailed herein relate to 3D alignment of radar and camera sensors. Specifically, transformation parameters between the radar and camera are determined for geometric alignment of the two types of sensors. Then, radar detections transformed to the camera frame of reference project onto the target image at the correct image coordinates. In the exemplary embodiment detailed herein, corner reflectors are used to determine the transformation parameters. In a radar system, a corner reflector appears as a strong point-like target with all reflected energy coming from near the apex. By inserting a light emitting diode (LED) in the apex of the corner reflector, image coordinates of the LED in the image obtained by the camera can be aligned with the apex detection by the radar system, as detailed below.

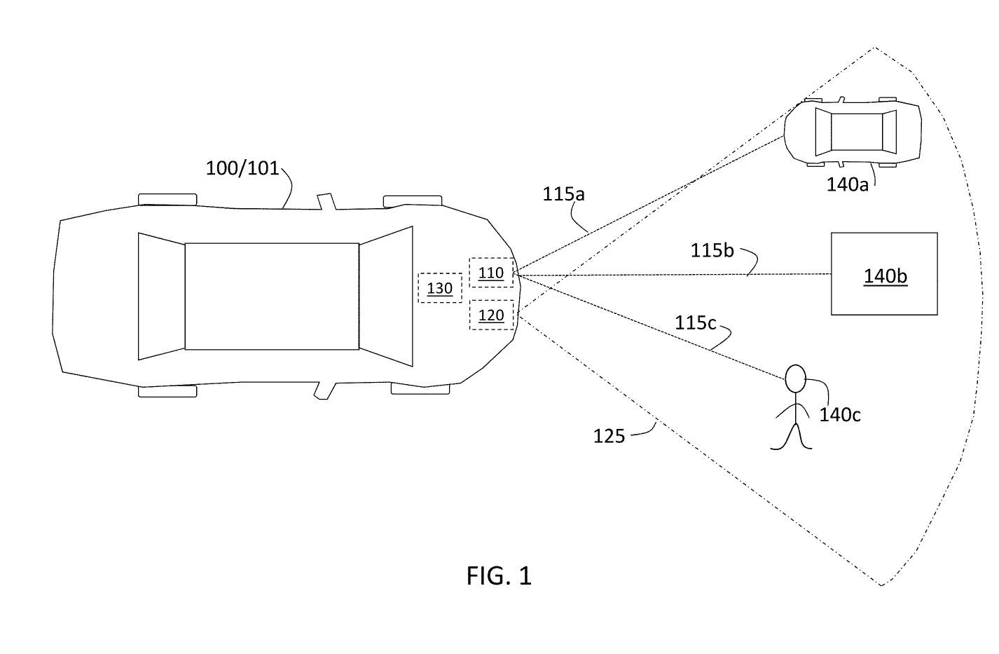

In accordance with an exemplary embodiment, FIG. 1 is a block diagram of a vehicle 100 that performs 3D alignment of radar 110 and camera 120 sensors. The exemplary vehicle 100 shown in FIG. 1 is an automobile 101. In addition to the radar 110 and camera 120, the vehicle 100 may include additional sensors (e.g., lidar, additional radar, additional camera) with FOV directed to cover the sides and rear of the vehicle 100. The vehicle 100 includes a controller 130 to align the radar 110 and camera 120. The controller 130 may be a stand-alone controller or may be part of one of the sensors or of the automation system of the vehicle 100, for example. The controller 130 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

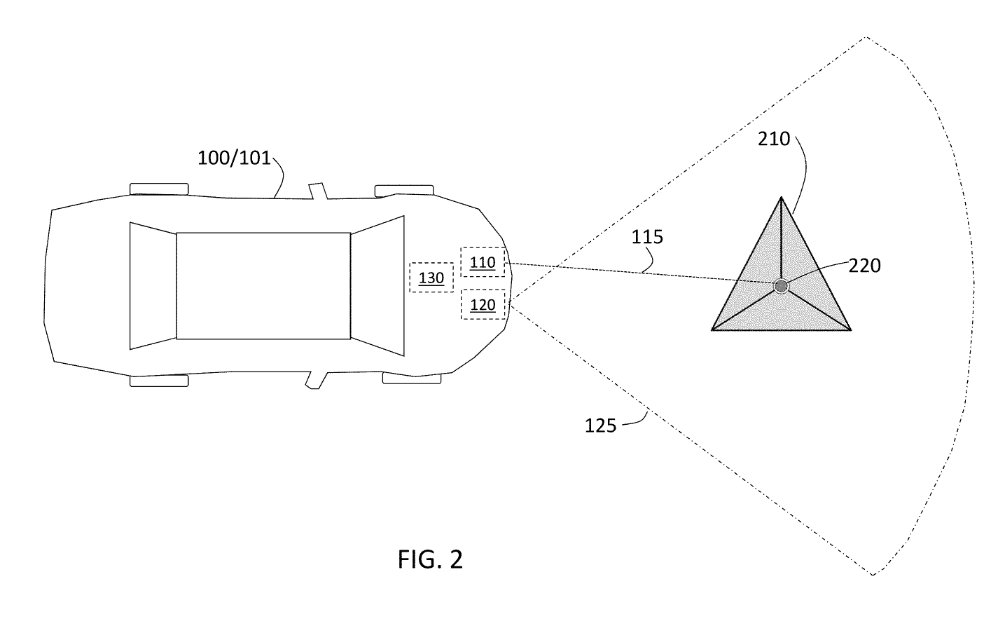

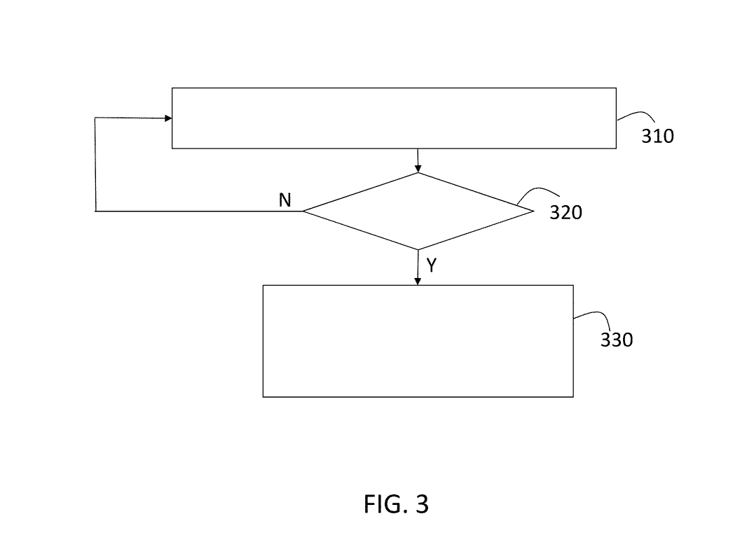

Three targets 140a, 140b, 140c (generally referred to as 140) are in the FOV of both the radar 110 and the camera 120 (camera FOV 125 is indicated in FIG. 1). Thus, reflections 115a, 115b, 115c (generally referred to as 115) are received by the radar 110 from each of the targets 140. These reflections 115 are processed by the radar 110 to obtain 3D information about the position (e.g., range, angle of arrival) of each target 140. Each of the targets 140 is also captured in an image by the camera 120. Based on transformation parameters (i.e., rotation matrix R, translation vector T) developed according to the processes discussed with reference to FIGS. 2 and 3, the targets 140 detected by the radar 110 may be transformed to the camera frame of reference and projected onto the image captured by the camera 120 at the correct image coordinates.

FIG. 2 depicts an exemplary arrangement to perform 3D alignment of the radar 110 and camera 120 according to one or more embodiments. As FIG. 2 indicates, a corner reflector 210 is positioned within the camera FOV 125 and within the FOV of the radar 110, as indicated by the reflection 115. As previously noted, the radar 110 perceives the corner reflector 210 as a point target at its center (apex). The detections appear with high intensity at zero Doppler shift and localized at or near the apex. The detections by the radar 110 are described in spherical polar coordinates (ρ, φ, υ) since the radar 110 assigns each detection a range, azimuth, elevation bin.

As also previously noted, the corner reflector 210 has an LED 220 in the center (i.e., at the apex) such that known image processing techniques performed by the controller 130 on an image obtained by the camera 120 identify the location of the LED 220 within the image. Two exemplary types of cameras 120—a pinhole camera and a fisheye camera—are discussed herein for explanatory purposes, but other types of known cameras 120 (i.e., any calibrated camera 120) may be used in the vehicle 100 and may be aligned according to the processes discussed with reference to FIG. 3. Camera models are known and are only generally discussed herein. Generally, the camera 120 involves a mapping F from a three-dimensional point \vec{X}=[X, Y, Z]^{T} to a two-dimensional image \vec{l}=[u, v]^{T}.

When the camera 120 is a pinhole camera,

$$\begin{matrix}u = f \frac{X}{Z} + {u}_{0} = f \tilde{X} + {u}_{0} & [ EQ . 1 ] \\ v = f \frac{Y}{Z} + {v}_{0} = f \tilde{Y} + {v}_{0} & [ EQ . 2 ]\end{matrix}$$

In EQS. 1 and 2, f is the focal length of the pinhole camera, and \vec{p}₀=[u₀,v₀]^{T} is the principle point of the pinhole camera. \tilde{X} and \tilde{Y} are normalized (or projective) coordinates. Distortions introduced by lenses of the camera 120 may be considered in the model for a more accurate representation of the position of the LED 220, for example. When the camera 120 is a fisheye camera, within the Equidistance model,

$$\begin{matrix}[ \begin{matrix}u \\ v\end{matrix} ] = \frac{c}{\sqrt{{X}^{2} + {Y}^{2}}} arctan ( \frac{\sqrt{{X}^{2} + {Y}^{2}}}{Z} ) [ \begin{matrix}X \\ Y\end{matrix} ] & [ EQ . 3 ] \\ [ \begin{matrix}u \\ v\end{matrix} ] = \frac{c}{\sqrt{{\tilde{X}}^{2} + {\tilde{Y}}^{2}}} arctan ( \frac{\sqrt{{\tilde{X}}^{2} + {\tilde{Y}}^{2}}}{Z} ) [ \begin{matrix}\tilde{X} \\ \tilde{Y}\end{matrix} ] & [ EQ . 4 ]\end{matrix}$$

In EQS. 3 and 4, c is model parameter, and \tilde{X} and \tilde{Y} are normalized (or projective) coordinates.

When the radar obtains a detected location qᵢ=[Xᵢ Yᵢ Zᵢ]^{T} for the corner reflector 210, the location qᵢ is first transformed to a location pᵢ in the frame of reference of the camera 120. The transformation is given by:

pᵢ=Rqᵢ+T [EQ. 5]

The projected image location (i.e., based on the mapping from the three-dimensional location pi to a two-dimensional image \vec{l}ᵢ is given by:

\vec{l}ᵢ=\vec{F}(pᵢ) [EQ. 6]

In EQ. 2, the symbol \vec{F} stresses the vector nature of the mapping. When the transformation (R, T) is correct, then \vec{l}ᵢ coincides or closely approximates the image location \vec{l}ᵢ^{c} of the LED 220 detected by the camera 120. The processes used to determine the rotation matrix R and the translation vector T are detailed with reference to FIG. 3.

FIG. 3 is a process flow of a method of performing 3D alignment of radar 110 and camera 120 sensors according to one or more embodiments. At block 310, the processes include positioning the corner reflector 210 within an area that represents an overlap in the camera FOV 125 and radar FOV and capturing measurements with the radar 110 and camera 120 to obtain sensor data. Sensor data refers to the radar 110 detecting the corner reflector 210 as a point target at its center and the camera 120 capturing an image showing the LED 220 at the center of the corner reflector 210. At block 320, a check is done of whether the position of the corner reflector 210 is the last position among a set of positions at which sensor data is obtained. If the corner reflector 210 is not at the last position among the set of positions, the corner reflector is positioned at the next position in the set of positions (within the area that represents an overlap in the camera FOV 125 and radar FOV) and the process at block 310 is repeated. If the corner reflector 210 is at the last position among the set of positions, then the process at block 330 is performed. At block 330, determining the rotation matrix R and the translation vector T from the sensor data involves a set of computations.

The initial estimate of the rotation matrix R and the translation vector T) (\hat{R},\hat{T}) may be obtained using a perspective-n-point (PnP) approach. PnP refers to the problem of estimating the pose of a camera 120 given a set of n 3D points in the world and their corresponding 2D projections in the image obtained by the camera. In the present case, the n 3D points qᵢ=[Xᵢ Yᵢ Zᵢ]^{T}, where i is the index from 1 to n and T indicates a transpose for a column vector, are detections by the radar 110 in the radar-centered frame of reference. In the camera-centered frame of reference, the corresponding points have the coordinates pᵢ=[X′ᵢ Y′ᵢ Z′ᵢ]^{T} according to EQS. 5 and 6 such that:

$$( \begin{matrix}{X}_{i}^{′} \\ {Y}_{i}^{′} \\ {Z}_{i}^{′}\end{matrix} ) = [ R T ] ( \begin{matrix}{X}_{i} \\ {Y}_{i} \\ {Z}_{i} \\ 1\end{matrix} ) \qquad [ EQ . 7 ]$$

At block 330, determining the rotation matrix R and the translation vector T involves determining the transformation (R, T) that minimizes the total camera-radar projection error. The cost function Φ is defined to facilitate the minimization.

Specifically, the cost function Φ is defined as the sum of squared Mahalanobis distances between the detected LED centers \vec{l}ᵢ=[uᵢ^{c},vᵢ^{c}]^{T} and the location of the apex of the corner reflector 210 at each different position, as detected by the radar 110 and projected onto the camera plane:

$$Φ ( R , T ) = {\sum }_{i} ( Δ {\vec{I}}_{i}^{T} {Σ}_{i}^{- 1} Δ {\vec{l}}_{i} ) \qquad [ EQ . 8 ]$$

In EQ. 8, Σ indicates the covariance matrix, which characterizes spatial errors. Using EQ. 6,

Δ\vec{l}ᵢ(R,T)=\vec{l}ᵢ^{c}−\vec{F}(pᵢ)=\vec{l}ᵢ^{c}−\vec{F}(Rqᵢ+T) [EQ. 9]

As EQ. 9 indicates, each covariance matrix Σ is composed of two parts, one relating to the camera 120 (c) and covariance of the detection of the LED 220 on the image and the other relating to the radar 110 (r) and covariance of the detection projected on the image plane:

Σᵢ=Σᵢ^{(c)}+Σᵢ^{(r)} [EQ. 10]

To calculate Σᵢ^{(r)} an analysis is done of the way the three-dimensional error of radar detection manifests itself in the two-dimensional covariance in EQ. 10. With p=[X, Y, Z]^{T} being a three-dimensional point in the camera 120 field of view and, according to EQ. 6, with \vec{l}=\vec{F}(p) being a projection of p on the image, a small change in p will result in:

$$δ \vec{l} = \frac{\partial \vec{F}}{\partial p} \cdot δ p \qquad [ EQ . 11 ]$$

In component notation, EQ. 11 may be written:

$$δ {l}_{u} = {\sum }_{j} \frac{\partial {F}_{μ}}{\partial {p}_{j}} δ {p}_{j} . \qquad [ EQ . 12 ]$$

With p₁=X, p₂=Y, p₃=Z, l₁=u, l₂=v, then the projected covariance is given by:

$${Σ}_{μ v}^{( r )} = 〈 δ {l}_{μ} δ {l}_{v} 〉 = {\sum }_{jk} \frac{\partial {F}_{μ}}{\partial {p}_{j}} \frac{\partial {F}_{v}}{\partial {p}_{k}} 〈 δ {p}_{j} δ {p}_{k} 〉 = {\sum }_{jk} ( \frac{\partial {F}_{μ}}{\partial {p}_{j}} \frac{\partial {F}_{v}}{\partial {p}_{k}} ) {Γ}_{jk} \qquad [ EQ . 13 ]$$

In EQ. 13, Γ is the covariance matrix describing the three-dimensional error of the radar detection, j, k=1, 2, 3, and μ, υ=1, 2.

Determining the R and T that minimize the cost function Φ, according to EQ. 8, involves solving for six parameters in total. This is because the rotation matrix R is parameterized by three angles (ψ, θ, ϕ) and translation vector T is parameterized by three components Tx, Ty, Tz. EQ. 8 is re-written by performing a Cholesky decomposition on Σᵢ⁻¹ as:

Σᵢ⁻¹=LᵢLᵢ^{T} [EQ. 14]

In EQ. 14, L denotes a lower triangular matrix with real and positive diagonal entries. Then the cost function Φ may be re-written in a form suitable for nonlinear least squares optimization:

$$Φ ( ψ , θ , φ , T ) = {\sum }_{i} {‖ {L}_{i}^{T} Δ {\vec{l}}_{i} ‖}^{2} \qquad [ EQ . 15 ]$$

From EQ. 15, the parameters associated with R and T may be estimated such that:

\hat{ψ},\hat{θ}ᵢ,\hat{ϕ}ᵢ,\hat{T}ₓ,\hat{T}_{y},\hat{T}_{z}=arg min[Φ(ψ,θ,ϕ,T)] [EQ. 16]

Optimization to determine the parameters of R and T may be performed using known tools and a standard numerical routine. Initial estimates may be obtained from geometric measurements of computer-aided design (CAD) drawings of sensor (radar 110 and camera 120) installation. As previously noted, a PnP estimation may be used for a perspective camera 120.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of performing a three-dimensional alignment of a radar and a camera with an area of overlapping fields of view, the method comprising:
positioning a corner reflector within the area;
obtaining sensor data for the corner reflector with the radar and the camera;
iteratively repositioning the corner reflector within the area and repeating the obtaining the sensor data; and
determining a rotation matrix and a translation vector to align the radar and the camera such that a three-dimensional detection by the radar projects to a location on a two-dimensional image obtained by the camera according to the rotation matrix and the translation vector.

2. The method according to claim 1, wherein the obtaining sensor data with the camera includes determining a position of a light emitting diode disposed at an apex position of the corner reflector in an image of the corner reflector.

3. The method according to claim 2, wherein the obtaining the sensor data with the radar includes detecting the apex position of the corner reflector as a point target.

4. The method according to claim 1, further comprising mapping a three-dimensional position obtained by operating on a radar detection with the rotation matrix and the translation vector to the location on the two-dimensional image.

5. The method according to claim 1, further comprising defining a cost function as a sum of squared Mahalanobis distances between a location of a center of the corner reflector as determined by the camera and the location of the center of the corner reflector as determined by the radar and projected on the two-dimensional image obtained by the camera for each position of the corner reflector in the area.

6. The method according to claim 5, wherein the determining the rotation matrix and the translation vector includes determining the rotation matrix and the translation vector that minimize the cost function.

7. The method according to claim 1, wherein the determining the rotation matrix includes determining three angle values.

8. The method according to claim 1, wherein the determining the translation vector includes determining three position components.

9. The method according to claim 1, wherein the obtaining the sensor data with the camera includes using a pinhole camera.

10. The method according to claim 1, wherein the obtaining the sensor data with the camera includes using a fisheye camera.

11. A system to align a radar and a camera with an area of overlapping fields of view, the system comprising:
a camera configured to obtain camera sensor data for a corner reflector positioned at different locations within the area;
a radar configured to obtain radar sensor data for the corner reflector at the different locations within the area; and
a controller configured to determine a rotation matrix and a translation vector to align the radar and the camera such that a three-dimensional detection by the radar projects to a location on a two-dimensional image obtained by the camera according to the rotation matrix and the translation vector.

12. The system according to claim 11, wherein the camera determines a position of a light emitting diode disposed at an apex position of the corner reflector in an image of the corner reflector.

13. The system according to claim 12, wherein the radar detects the apex position of the corner reflector as a point target.

14. The system according to claim 11, wherein the controller is further configured to map a three-dimensional position obtained by operating on a radar detection with the rotation matrix and the translation vector to the location on the two-dimensional image.

15. The system according to claim 11, wherein the controller is further configured to define a cost function as a sum of squared Mahalanobis distances between a location of a center of the corner reflector as determined by the camera and the location of the center of the corner reflector as determined by the radar and projected on the two-dimensional image obtained by the camera for each position of the corner reflector in the area.

16. The system according to claim 15, wherein the controller is further configured to determine the rotation matrix and the translation vector to minimize the cost function.

17. The system according to claim 11, wherein the controller is further configured to determine the rotation matrix as three angle values.

18. The system according to claim 11, wherein the controller is further configured to determine the translation vector as three position components.

19. The system according to claim 11, wherein the camera is a pinhole camera, and the pinhole camera and the radar are in a vehicle.

20. The system according to claim 11, wherein the camera is a fisheye camera, and the fisheye camera and the radar are in a vehicle.
